(19) United States
(12) Patent Application Publication
(10) Pub. No.: US 2005/0000250 A1
(43) Pub. Date: Jan. 6, 2005

(54) Method for producing a tube consisting of quartz glass, tubular semi-finished product consisting of porous quartz glass, and the use of the same

(76) Inventors: Oliver Humbach, Ewerswinkel (DE); Frank Gansicke, Wachtersbach (DE); Dirk Kruber, Bonn (DE); Marcus Dietrich, Darmstadt (DE); Ralph Sattmann, Aschaffenburg (DE)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 10/493,774

(22) PCT Filed: Oct. 9, 2002
(86) PCT No.: PCT/EP02/11278

(30) Foreign Application Priority Data
Oct. 26, 2001 (DE) 101 52 328.9

(51) Int. Cl. C03B 19/01; C03B 19/06; C03B 37/018

(52) U.S. Cl. 65/413; 65/17.3; 65/17.4; 65/17.5; 65/421; 65/427

(57) ABSTRACT

In a known method for producing a quartz glass tube by means of flame hydrolysis of a silicon-containing start component, SiO₂-containing particles are produced, said particles are deposited on a carrier, forming a soot tube having a porous soot wall with a predetermined radial soot density profile, and the soot tube is treated in a chlorine-containing atmosphere and is then vitrified. To modify said method in such a way that a predetermined radial refractive index distribution is obtained also after dehydration treatment in a chlorine-containing atmosphere, it is suggested according to the invention that the density should be adjusted in such a way that in an inner region of the soot wall it is increased to at least 25% of the density of quartz glass, in an outer region of the soot wall the density is reduced, and in a transition region adjoining the inner region, the density decreases towards the outer region, with the proviso that the transition region extends over at least 75% of the thickness of the soot wall. The inventive tubular semi-finished product is characterized by a soot wall having, in an inner region, a density which is increased to at least 25% of the density of the quartz glass, a reduced density in an outer region, and, in a transition region adjoining the inner region, a density which decreases towards the outer region, said transition region extending over at least 75% of the thickness of the soot wall

The present invention relates to a method for producing a quartz glass tube by means of flame hydrolysis of a silicon-containing start component, comprising method steps in which the start component is supplied to a deposition burner by means of which SiO₂-containing particles are produced, said particles are deposited on a carrier rotating about its longitudinal axis, forming a soot tube having a porous soot wall with a predetermined radial soot density profile, the soot tube is treated in a chlorine-containing atmosphere, and the treated soot tube is vitrified.

Furthermore, the present invention relates to a tubular semi-finished product of quartz glass with a porous SiO₂ soot wall having a predetermined radial density profile, and to the use of such a tube.

Quartz glass tubes are used as a starting material for preforms for optical fibers. The preforms have, in general, a core which is clad by a jacket of a material having a lower refractive index. For producing the core of preforms from synthetic quartz glass, methods have been established that are designated as VAD method (vapor-phase axial deposition), OVD method (outside vapor-phase deposition), MCVD method (modified chemical vapor-phase deposition), and PCVD method (plasma chemical vapor-phase deposition). In all of these methods, the core glass is produced in that SiO₂ particles are deposited on a substrate and vitrified. The core glass is deposited in VAD and OVD methods from the outside on a substrate, and in MCVD and PCVD methods on the inner wall of a so-called substrate tube. The substrate tube may have a pure support function for the core material, but it may also be formed itself as part of the light-guiding core. Depending on the fiber design, the substrate tube consists of doped or undoped quartz glass. Moreover, the production of preforms according to the so-called rod-in-tube technique is known, wherein a rod of a core glass is introduced into a tube of cladding glass and melted therewith. Elongation of the preform yields optical fibers.

Depending on the respective process, the cladding glass is produced in a separate method (OVD, plasma method, rod-in-tube technique), or the cladding glass and the core glass are produced at the same time, as is standard in the so-called VAD method. The difference in the refractive indices between core glass and cladding glass is set by admixing suitable dopants. It is known that fluorine and boron decrease the refractive index of quartz glass while a great number of dopants are suited for increasing the refractive index of quartz glass, particularly germanium, phosphorus, or titanium.

The refractive index of quartz glass is also slightly increased by chlorine. This effect of chlorine must particularly be heeded in the production of quartz glass from chlorine-containing start materials, such as SiCl₄, and in the treatment of porous “soot bodies” in a chlorine-containing atmosphere. For instance, EP-A 604 787 describes the production of doped quartz glass tubes according to the so-called “soot method”, wherein particles are formed by flame hydrolysis of the start components SiCl₄ and GeCl₄ in a deposition burner, and said particles are deposited in layers on a carrier rod rotating about its longitudinal axis, in that the deposition burner is reciprocated in an oscillating way along the carrier rod. In this process, a porous soot wall doped with GeO₂ is formed from SiO₂ particles. A cladding glass layer of undoped SiO₂ is subsequently deposited thereon. After removal of the carrier rod the tubular soot body produced in this way is purified and dehydrated, which is normally done by heating in a chlorine-containing atmosphere. A so-called core rod which is surrounded with further cladding glass for completing the preform is obtained by vitrifying (sintering) the dehydrated soot body. An optical fiber is drawn from the preform.

During dehydration in a chlorine-containing atmosphere, there may be an incorporation of chlorine into the soot body, and also a leaching of GeO₂ in a GeO₂-containing soot body.

These effects of chlorine during dehydration of a porous soot wall normally lead to a deviation in the radial refractive index curve from the desired profile in the preform. In the case of a desired profile with a refractive index curve that is constant over the soot wall (hereinafter also called “homogeneous radial refractive index curve”), a refractive index that is radially decreasing from the inside to the outside is often obtained after dehydration. This yields a normally undesired change in the light-guiding properties of an optical fiber, e.g. the so-called cutoff wavelength. Moreover, the deposition rate during internal deposition on substrate tubes according to the MCVD and PCVD method is affected by the chlorine distribution, which may lead to irregular deposition rates.

Hence, it is the object of the present invention to modify the generic method for producing a quartz glass tube, comprising a soot deposition process, a dehydration treatment in a chlorine-containing atmosphere, and a vitrification process, in such a way that a predetermined radial refractive index distribution is obtained.

Furthermore, it is the object of the present invention to provide a tubular semi-finished product of porous quartz glass, in the case of which an adjustment of a predetermined curve of the refractive index over the tubular wall is even obtained after dehydration treatment by heating in a chlorine-containing atmosphere.

A further object of the invention consists in indicating a suitable use of the tubular semi-finished product produced according to the invention.

As for the method, said object, starting from the above-indicated method, is achieved according to the invention in that the density is adjusted such that in an inner region of the soot wall it is increased to at least 25% of the density of quartz glass, in an outer region of the soot wall the density is reduced, and in a transition region adjoining the inner region, the density decreases towards the outer region, with the proviso that the transition region extends over at least 75% of the thickness of the soot wall.

During dehydration treatment of the soot tube, there may be a radially inhomogeneous incorporation of chlorine or at least a radially inhomogeneous effect of the chlorine within the soot wall, which contributes to an inhomogeneous refractive index distribution in the vitrified tube. Surprisingly, it has been found that such a radially inhomogeneous effect of the chlorine can be compensated or eliminated by adjusting a specific radial density profile in the soot body such that after vitrification a quartz glass tube is obtained with a radially homogeneous refractive index distribution.

The special radial density profile required therefor is characterized in that in a transition portion the density decreases from an increased value of at least 25% (in the inner region) towards the outside up to the outer region of the soot wall. Ideally, the transition region extends over the whole soot wall—in this case the inner region coincides with the inner wall of the soot tube, and the outer region ends at the outer free surface of the soot tube. The desired technical success will even be obtained, though to a reduced degree, when the inner region is shifted to the outside or the outer region to the inside, with the proviso that the transition region positioned thereinbetween accounts for at least 70% of the thickness of the soot wall. The desired result is not achieved when a region of a high density of more than about 28% is present between the outer free surface of the soot tube and the transition region.

The data on the relative density inside the soot wall are based on a quartz glass density of 2.21 g/cm³. For measuring the density, samples are taken from the soot wall and measured by way of X-ray methods.

The carrier is a rod-like or tubular body of graphite, of a ceramic material such as aluminum oxide, of undoped quartz glass, of doped quartz glass, or of doped or undoped porous SiO₂ soot. Carriers of doped quartz glass or doped SiO₂ soot may also have a radially inhomogeneous dopant distribution and may particularly be designed as a semi-finished product for optical fibers as a so-called “core rod” with a radially inhomogeneous refractive index profile.

Hence, the method of the invention aims at a homogenization of the refractive index curve through a density profile that accounts for the whole soot wall or at least the major part thereof (>70%) and is substantially characterized by a density decreasing from the inside to the outside.

Preferably, a difference in the range between 1% and 15%, preferably in the range between 4% and 12% of the density of quartz glass, is set between the increased density in the inner region and the reduced density in the outer region. It has been found that for the adjustment of a homogeneous refractive index distribution in the vitrified quartz glass tube the difference of the densities of inner region and outer region is decisive, but not the density gradient in the transition region. The same density difference (differential amount) is obtained in thick-walled soot tubes with a smaller density gradient and in thin-walled soot tubes with a greater density gradient in the transition region.

In consideration of said density differences between inner region and outer region, it has turned out to be of advantage when in the inner region a density is adjusted between 25% and 35%, preferably between 28% and 32%, and, in the outer region, a density between 20% and 27%, preferably between 20% and 24% (each of the data on density being based on the density of quartz glass).

It has been found that such a radial density profile achieves a more uniform distribution or a more homogeneous action of chlorine over the wall thickness of the soot wall, so that the radial refractive index profile in the vitrified soot tube is less affected by the preceding dehydration treatment in a chlorine-containing atmosphere.

In the method according to the invention, the soot tube is preferably vitrified by the tube being heated from the outside, forming an inwardly migrating melt front. The melt front is moving in this process from a region of reduced soot density into a region of increased density. The advantageous effect of said measure can be explained by the fact that a chlorine concentration profile that is homogenized by the melt front migrating from the outside to the inside has been set by the preceding dehydration treatment over the wall thickness of the soot tube.

Advantageously, a continuously decreasing density is adjusted in the transition region. Due to a continuous constant decrease in density from the inside to the outside within the transition region, local steps and accompanying changes in the effect of chlorine are avoided, so that the adjustment of a homogeneous refractive index profile in the vitrified soot tube is facilitated. This is supported when a substantially linearly decreasing density is adjusted in the transition region. The decrease in density in the transition region is of a macroscopic type, averaged over a length of about 10 mm. Slight deviations from a continuously constant density decrease and density variations in the microscopic range do not impair the success of the method according to the invention.

The density which is decreasing from the inside to the outside in the transition region is preferably obtained by gradually decreasing the surface temperature of the developing soot tube during deposition. The increased density is expediently set such that the surface temperature is increased during deposition. An additional method step for a post-densification is here not needed. Many measures are suited for increasing the surface temperature. Reference is here made by way of example to the following measures: Setting an increased flame temperature of the deposition burner, changing the distance between deposition burner and soot tube surface, reducing the speed of the relative movement between deposition burner and soot tube. A decrease in the surface temperature is achieved by opposite measures.

Ideally, the inner region directly begins on the inner wall of the soot tube. However, especially the first layers of the soot wall are often designed in conformity with special requirements (stability, elasticity, etc.) and may have a lower density matched to said requirements. In such cases, the inner region is marked by a maximum of the soot density, and the region of the density decreasing from the inside to the outside (transition region) starts at a distance from the inner wall, said distance being advantageously not more than 30 mm, preferably not more than 20 mm.

As for the tubular semi-finished product, the above-indicated object is achieved according to the invention in that the soot wall in an inner region has an increased density of at least 25% of the density of quartz glass, a reduced density in the outer region, and a density decreasing towards the outer region in a transition region adjoining the inner region, with the proviso that the transition region extends over at least 75% of the thickness of the soot wall.

Such a tubular semi-finished product of porous quartz glass will also be designated as a “soot tube” in the following. A quartz glass tube is produced from the soot tube by vitrification (sintering). The soot tube according to the invention is characterized by the above-described radial density curve over the soot wall. Said density curve assists in obtaining a quartz glass tube with a homogeneous refractive index curve over the tube wall by vitrification with a preceding dehydration treatment in a chlorine-containing atmosphere.

A possible explanation for this effect is that the inhomogeneous density curve as has been described assists in preventing a locally different action of chlorine during the dehydration treatment or in compensating the same.

It is essential that the density within the transition region decreases from the inside to the outside. Ideally, the transition region extends over the whole soot wall, the inner region terminating in this case at the inner free surface and the outer region at the outer free surface of the soot tube. The desired technical effect is also achieved, though to a reduced degree, when the inner region only begins at a distance from the inner wall of the tubular soot wall and/or the outer region at a distance from the outer jacket. Preferably, however, the intermediate transition region accounts for at least 75% of the thickness of the soot wall. The desired result is not achieved when a region of a high density of more than about 28% is present between the outer free surface of the soot tube and the transition region.

During use of soot tubes according to the prior art for producing quartz glass tubes, the radial refractive index distribution thereof is impaired by the action of chlorine due to a preceding dehydration treatment. By contrast, the soot tube according to the invention is characterized in that the adjustment of a homogeneous curve of the refractive index over the wall of the vitrified quartz glass tube is facilitated although it is subjected to a dehydration treatment by heating in a chlorine-containing atmosphere. The effects of the chlorine are eliminated or compensated by the above-explained intermediate configuration of a predetermined density curve in the transition region, so that a quartz glass tube of a predetermined refractive index profile and with a low hydroxyl group content at the same time can be provided, using a soot tube according to the invention.

Advantageous embodiments of the soot tube are indicated in the sub-claims. Reference is made to the detailed explanations regarding the method of the invention, also in connection with the radial expansion of the transition region and the density curve between inner region and outer region.

After removal of the carrier, the vitrified tubular soot tube can be used as a so-called “jacket tube” for cladding a core rod of a preform.

The soot tube, however, can also be vitrified on the carrier. In the case of a carrier of doped or undoped quartz glass, especially in the case of a carrier in the form of a core rod, a preform for optical fibers or part of such a preform can be produced.

Due to its homogeneous radial refractive index curve, the soot tube of the invention, however, can particularly be used for producing a preform for optical fibers in that the semi-finished product is vitrified, elongated under formation of a substrate tube, and core material is deposited on the inner wall of the substrate tube by means of a MCVD method or by means of a PCVD method.

After vitrification and elongation the substrate tube has a predetermined homogeneous refractive index distribution over the tube wall. The substrate tube produced in this way is therefore particularly suited for producing preforms in the case of which defined refractive index profiles are of importance.

A further advantageous possibility of using the soot tube of the invention consists in using said tube after dehydration treatment and vitrification as a jacket material for forming a preform for optical fibers in that a so-called core glass rod is provided and clad by the quartz class tube. The hydroxyl group content must be low in this instance. This is achieved in that the porous soot tube is subjected to a hot chlorination method. Moreover, a refractive index profile that is as homogeneous as possible must be observed. As indicated above, this is achieved in the soot tube according to the invention by the intermediate formation of a predetermined density curve in the transition region and a subsequent dehydration treatment, so that a quartz glass tube of the predetermined refractive index profile and with a slow hydroxyl group content at the same time is obtained from the soot tube.

The invention will now be explained in more detail with reference to embodiments and a drawing, the drawing showing in detail in

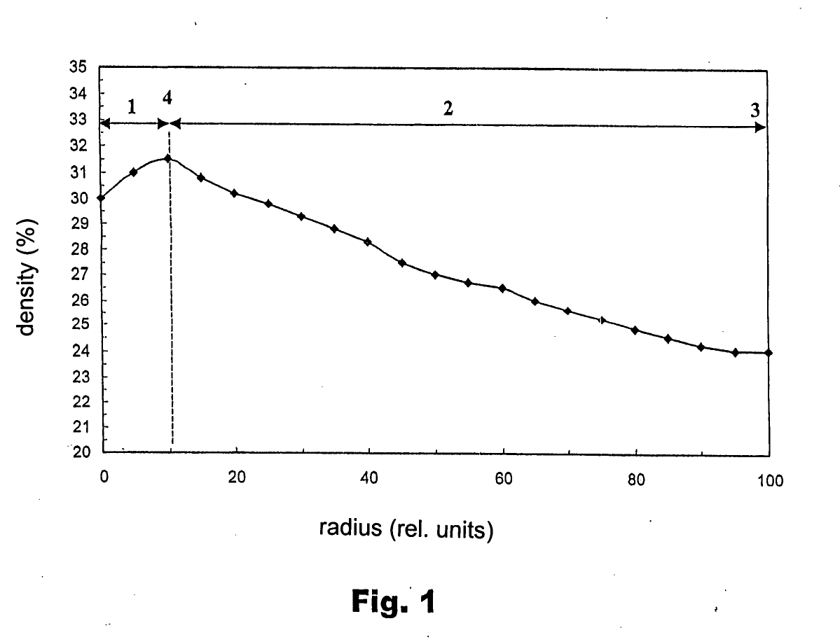

FIG. 1 a radial density profile over the wall of a porous SiO₂ soot tube according to the invention, prior to vitrification;

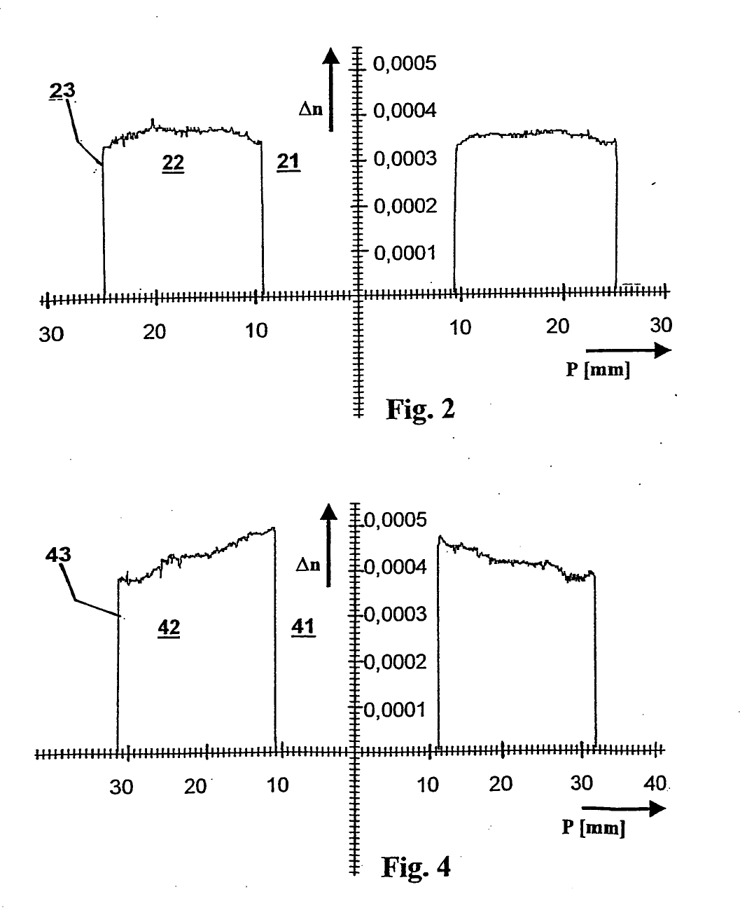

FIG. 2 a refractive index profile, measured on a quartz glass tube, which has been obtained by vitrification and elongation from the SiO₂ soot tube, according to FIG. 1;

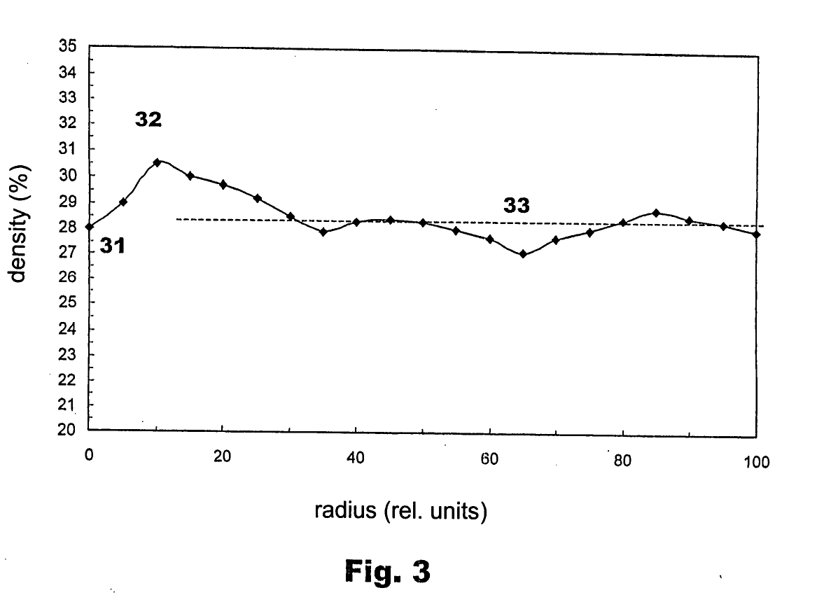

FIG. 3 a radial density profile over the wall of a porous SiO₂ soot tube according to the prior art before vitrification (comparative example); and

FIG. 4 a refractive index profile, measured on a quartz glass tube, which has been obtained by vitrification and elongation of the SiO₂ soot tube, according to FIG. 3.

Each of FIGS. 1 and 3 shows radial density profiles over the wall of a porous soot tube in the process stage prior to dehydration treatment and prior to vitrification. On the y-axis, the specific density of the soot tube is plotted in relative units (in %, based on the theoretical density of quartz glass). The x-axis designates the radius in relative units, based on the total wall thickness of the soot body. The radius “0” corresponds to the inner wall of the soot body; the radius “100” to the outer wall. Each of the measured soot tubes has an inner diameter of about 50 mm and an outer diameter of about 320 mm.

Each of FIGS. 2 and 4 shows radial refractive index profiles of a quartz glass tube in the process stage after dehydration treatment and after vitrification. Plotted on the y-axis is the refractive index difference “Δn” in comparison with undoped quartz glass. The x-axis designates the radial position “P” in millimeter over the whole quartz glass tube. The position “P=0” designates the central axis of the inner bore.

### EXAMPLE

In the radial density profile according to FIG. 1, the soot density first increases from the inside to the outside in an inner region 1 and then, starting from a maximum 4 of about 33%, decreases gradually in a transition region 2 from the inside to the outside, reaching a value of 24% in the region of the outer jacket 3. Inside the transition region 2, the soot density thus decreases by a total of 9%. The transition region 2 constitutes about 90% of the wall thickness of the soot tube. Adjoining the inner region 1, it starts at the soot density maximum 4 at a distance of about 15 mm from the inner wall 5 and extends radially over a length of about 120 mm to the outside up to the outer jacket 3.

After the deposition process the soot tube is subjected to a dehydration treatment and is then vitrified, forming a quartz glass tube. FIG. 2 shows the refractive index profile measured thereafter on the quartz glass tube. The wall 22 of the quartz glass tube adjoining the inner bore 21 shows an increase in refractive index of about Δn=0.0004 in comparison with pure quartz glass. It is striking that the refractive index curve over the wall 22 of the quartz glass tube is substantially homogeneous from the inner bore 21 up to the outer wall 23.

The production of a soot tube with the density profile shown in FIG. 1 and of a quartz glass tube with the refractive index profile shown in FIG. 2 will now be explained by way of example.

SiO₂ soot particles are formed by flame hydrolysis of SiCl₄ in the burner flame of a deposition burner, and said particles are deposited in layers on a carrier rod rotating about its longitudinal axis, forming a soot body. For forming the radial density curve, as shown in FIG. 2, inside the soot body, a comparatively high surface temperature is produced during deposition of the first soot layers and a soot region of a comparatively high density of about 30% is thus produced. Thereupon the soot density is still increased further in a gradual manner until it reaches the maximum 4 at about 32% at the above-indicated distance of about 15 mm.

It is at this point that the “transition region” 2 begins within the meaning of the present invention. Upon deposition of the subsequent soot layers, the surface temperature of the developing soot body is continuously lowered and the soot density is thus reduced. To this end the rotational speed of the carrier rod is continuously reduced, namely in such a way that the circumferential speed of the enlarging soot body surface remains constant. Due to the increase in the circumference of the soot body, the surface temperature decreases at a constant temperature of the burner flame. This yields the radial density gradient shown in FIG. 1. For producing a steeper or flatter gradient, the temperature of the flame of the deposition burner is changed by varying the feed rates of the combustion gases hydrogen and oxygen.

After completion of the deposition process and removal of the carrier rod, a soot tube is obtained with the density profile shown in FIG. 1. A quartz glass tube is produced from the soot tube with the help of the method explained by way of example in the following:

The soot tube obtained according to the method steps explained above in more detail is subjected to a dehydration treatment for removing the hydroxyl groups introduced due to the production process. To this end the soot tube is introduced in vertical orientation into a dehydration furnace and is first treated at a temperature of about 900° C. in a chlorine-containing atmosphere. The treatment lasts for about eight hours. This yields a hydroxyl group concentration of less than 100 wt. ppb.

The effects of the chlorine acting during dehydration treatment on the porous soot material are compensated by the high density in the inner region 1 and the density curve in the transition region 2, so that a quartz glass tube having the predetermined homogeneous refractive index profile according to FIG. 2 can be obtained, using the soot tube according to the invention.

For producing the quartz glass tube with the refractive index profile shown in FIG. 2, the soot tube is sintered in a vertically oriented vitrification furnace at a temperature in the range of about 1300° C. in that it is supplied to an annular heating zone and heated therein zonewise. In this process a melt front is migrating from the outside to the inside. Subsequently, the sintered (vitrified) tube is elongated to an outer diameter of 46 mm and an inner diameter of 17 mm.

Apart from a homogeneous refractive index distribution, the quartz glass tube obtained in this way shows a low hydroxyl group concentration, which permits a use in the near-core region of a preform for optical fibers.

By comparison, FIGS. 3 and 4 show a radial density profile in a soot tube according to the prior art and a refractive index profile of a quartz glass tube produced therefrom.

### Comparative Example

FIG. 3 shows the radial density profile of a soot tube produced according to the former method. Apart from a maximum 32 at a distance of about 15 mm from the inner wall 3 with a soot density of about 40.5%, the density is substantially constant over the wall thickness of the soot tube and is, on average, about 28% (broken line 33).

After the deposition process, the soot tube is subjected to the same dehydration treatment, as explained with reference to the above example, and is then vitrified and elongated, resulting in a quartz glass tube having an outer diameter of 64 mm and an inner diameter of 22 mm.

The refractive index profile was measured on the quartz glass tube. The result is shown in FIG. 4. Inside the wall 42 of the quartz glass tube that adjoins the inner bore 41, the refractive index considerably decreases from the inside to the outside. Starting from a maximum value of about +0.0005 in the region of the inner wall 41, the refractive index decreases by more than 30% to less than +0.00035 in the region of the outer wall 42. Hence, a quartz glass tube with a radially inhomogeneous refractive index distribution was obtained by vitrification and elongation of the soot tube according to the prior art.

The quartz glass tube according to the invention is preferably used as a substrate tube for the internal deposition of core material layers according to the MCVC method.

1. A method for producing a quartz glass tube by flame hydrolysis of a silicon-containing start component, said method comprising: supplying the start component to a deposition burner by which SiO₂-containing particles are produced, wherein said particles are deposited on a carrier rotating about a longitudinal axis thereof, so as to form a soot tube having a porous soot wall with a predetermined radial soot density profile, treating the soot tube is in a chlorine-containing atmosphere, and vitrifying the treated soot tube, wherein the soot wall has an inner region having an increased density of at least 25% of the density of quartz glass, an outer region of the soot wall having a reduced density such that there is a difference in density between the increased density in the inner region and the reduced density in the outer region ranging between 4% and 12%, and a transition region adjoining the inner region and having a density that decreases towards the outer region, wherein the transition region extends over at least 75% of the thickness of the soot wall.

2. The method according to claim 1, wherein in the inner region the increased density is between 25% and 35% of the density of quartz glass.

3. The method according to claim 1, wherein the soot tube is vitrified by being heated from the outside so as to form an inwardly migrating melt front.

4. The method according to claim 1, wherein the density in the transition region decreases continuously toward the outer region of the soot wall.

5. The method according to claim 4, wherein the density in the transition region decreases substantially linearly toward the outer region of the soot wall.

6. The method according to claim 1, wherein the density decreasing in the transition region from the inner region to the outer region is obtained by reducing a surface temperature of the soot tube as said soot tube is formed.

7. The method according to claim 1, wherein the inner region is not more than 30 mm away from an inner wall of the soot tube.

8. The method according to claim 7, wherein the inner region is not more than 20 mm away from the inner wall of the soot tube.

9. The method according to claim 2, wherein in the inner region the increased density is between 28% and 32% of the density of quartz glass.

10. The method according to claim 2, wherein in the outer region the reduced density is between 20% and 27% of the density of quartz glass.

11. The method according to claim 9, wherein in the outer region the reduced density is between 20% and 27% of the density of quartz glass.

12. The method according to claim 2, wherein in the outer region the reduced density is between 20% and 24% of the density of quartz glass.

13. The method according to claim 9, wherein in the outer region the reduced density is between 20% and 24% of the density of quartz glass.

14. The method according to claim 2, wherein the density in the transition region decreases continuously toward the outer region of the soot wall.

15. The method according to claim 14, wherein the density in the transition region decreases substantially linearly toward the outer region of the soot wall.

16. The method according to claim 9, wherein the density in the transition region decreases continuously toward the outer region of the soot wall.

17. The method according to claim 16, wherein the density in the transition region decreases substantially linearly toward the outer region of the soot wall.

18. The method according to claim 10, wherein the density in the transition region decreases continuously toward the outer region of the soot wall.

19. The method according to claim 18, wherein the density in the transition region decreases substantially linearly toward the outer region of the soot wall.

20. The method according to claim 11, wherein the density in the transition region decreases continuously toward the outer region of the soot wall.

21. The method according to claim 20, wherein the density in the transition region decreases substantially linearly toward the outer region of the soot wall.

22. The method according to claim 12, wherein the density in the transition region decreases continuously toward the outer region of the soot wall.

23. The method according to claim 22, wherein the density in the transition region decreases substantially linearly toward the outer region of the soot wall.

24. The method according to claim 13, wherein the density in the transition region decreases continuously toward the outer region of the soot wall.

25. The method according to claim 24, wherein the density in the transition region decreases substantially linearly toward the outer region of the soot wall.
